(19) United States
(12) Patent Application Publication
(10) Pub. No.: US 2002/0049757 A1
(43) Pub. Date: Apr. 25, 2002

(54) Apparatus for processing data of overlapped facilities by means of virtual facility record and method therefor

(76) Inventors: Seong-Beom Kim, Taejon (KR); Jae-Woo Jeong, Taejon (KR); Geon-Ho Kim, Taejon (KR); Ki-Cheol Kim, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/737,394

(22) Filed: Dec. 14, 2000

(30) Foreign Application Priority Data
Oct. 19, 2000 (KR) 2000-61580

(51) Int. Cl. G06F 17/30

(52) U.S. Cl. 707/8

(57) ABSTRACT

An apparatus for processing data of overlapped facilities occupying the same graphical position in a drawing representing their layout by means of virtual facility records, includes a first data processing device for storing, maintaining, and managing the real records of the overlapped facilities, and a second data processing device for storing, maintaining, and managing the virtual records of the overlapped facilities representing the real records having the same graphic coordinates.

### FIELD OF THE INVENTION

The present invention relates to an apparatus for processing data of overlapped facilities that occupy the same graphical position in a drawing representing their layout to manage them, and method therefor.

### PRIOR ART OF THE INVENTION

The conventional database for managing a layout drawing representing the overlapped facilities is designed so that they are registered in their respective records. Therefore, the graphic coordinates and the values representing the common attributes are duplicated in each facility record, so that if the value of a record is changed, the other records overlapped with the same graphic coordinates should be changed through the database or a suitable application program.

This causes increase of data inconsistency, and increase a volume of database to result in increase of the time taken for searching and retrieving data. Moreover, when displaying on the screen or printing out the layout drawing, additional data processing is required in order to prevent the facilities with the same graphic coordinates from being outputted overlapped.

### SUMMARY OF THE INVENTION

It is an object of the present invention to provide an apparatus for processing data of overlapped facilities occupying the same graphical position in a drawing representing their layout by means of virtual facility record, and a method therefor, and a recording medium programmed by a computer to perform the method.

In accordance with an aspect of the present invention, there is provided an apparatus for processing data of overlapped facilities occupying the same graphical position in a drawing representing their layout by means of virtual facility records, includes: a first data processing device for storing, maintaining and managing the real records of the overlapped facilities; a second data processing device for storing, maintaining and managing the virtual records of the overlapped facilities representing the real records having the same graphic coordinates.

In accordance with another aspect of the present invention, there is provided a method for processing data of overlapped facilities occupying the same graphical position in a drawing representing their layout by means of virtual facility records, the method includes the steps of: establishing a real facility table by using the real records of the overlapped facilities; and establishing a virtual facility table by using the virtual records of the overlapped facilities representing the real records having the same graphic coordinates.

In accordance with a further aspect of the present invention, there is provided a computer readable recording media storing instructions for executing a method for processing data of overlapped facilities, the method comprising the steps of: establishing a real facility table by using the real records of the overlapped facilities; and establishing a virtual facility table by using the virtual records of the overlapped facilities representing the real records having the same graphic coordinates.

### BRIEF DESCRIPTION OF THE DRAWINGS

The above and other objects and features of the instant invention will become apparent from the following description of preferred embodiments taken in conjunction with the accompanying drawings, in which:

FIG. 1 is a diagram for illustrating the conventional structure of the database for processing the data of the overlapped facilities;

FIG. 2 is a diagram for illustrating the inventive structure of the database for processing the data of the overlapped facilities;

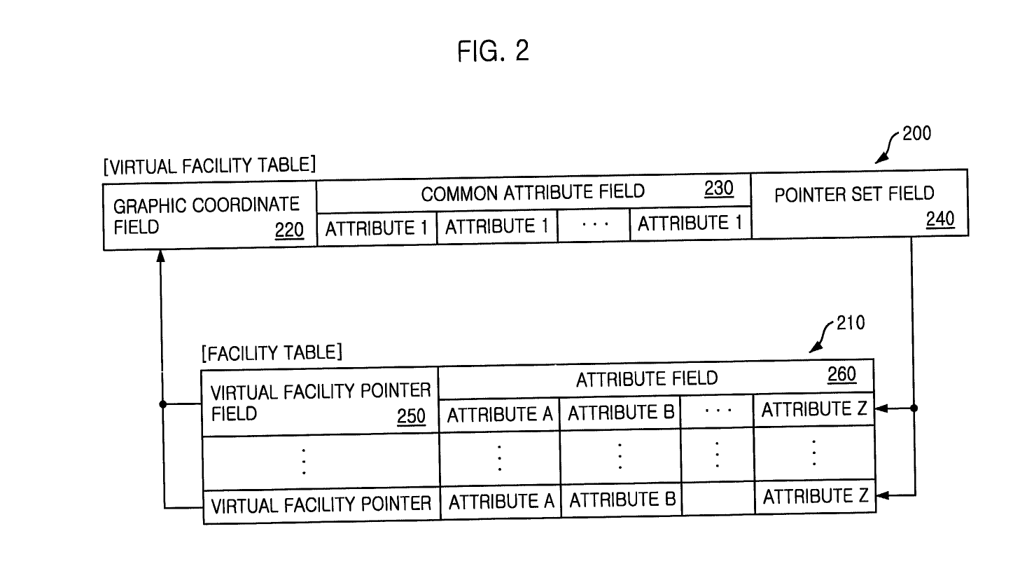

FIG. 3 is a flow chart for illustrating the procedure of displaying the data for processing the data of the overlapped facilities according to an embodiment of the present invention;

FIG. 4 is a flow chart for illustrating the procedure of inputting the data for processing the data of the overlapped facilities according to an embodiment of the present invention;

FIG. 5 is a flow chart for illustrating the procedure of adding the data for processing the data of the overlapped facilities according to an embodiment of the present invention; and

FIG. 6 is a flow chart for illustrating the procedure of deleting the data for processing the data of the overlapped facilities according to an embodiment of the present invention.

### PREFERRED EMBODIMENT OF THE INVENTION

Hereinafter, preferred embodiments of the present invention will be described in detail with reference to the accompanying drawings.

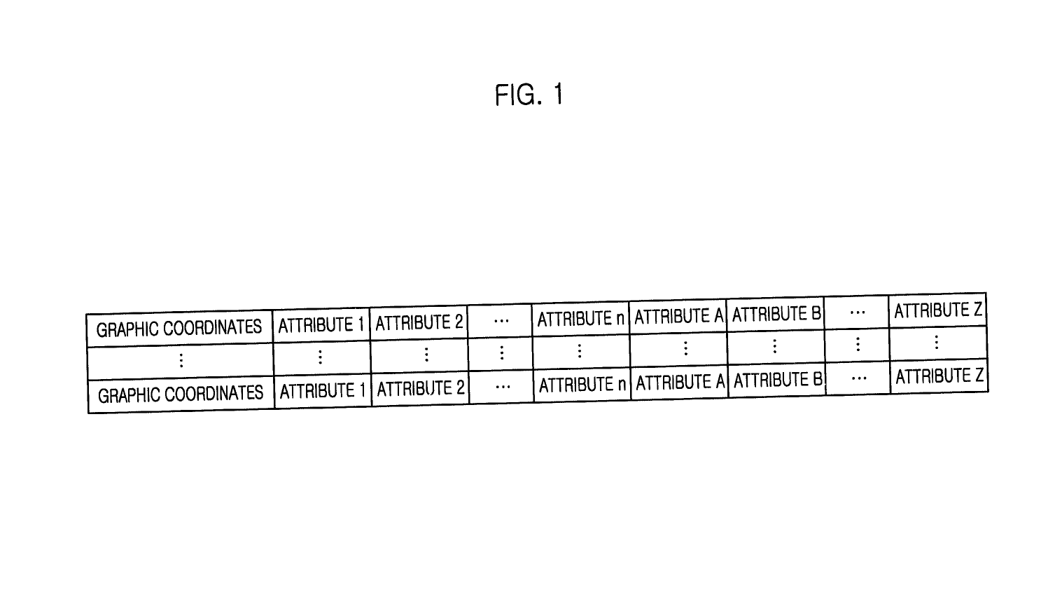

FIG. 1 illustrates the facility table for the data structure of the conventional apparatus for processing the data of the overlapped facilities. In the records of the facility table, the graphic coordinate fields all have the same value, the fields of the attributes 1, 2, . . . , n also all have the same value, and the fields of the attributes A, B, . . . , Z have different values according to the records. Hence, the graphic coordinate values and common attribute values are multiply registered in each record, so that if changing the value of a record, the other records overlapped with the same graphic value should be changed through the database or application program.

However, the inventive apparatus for processing the data of the overlapped facilities includes a facility table 210 for storing, maintaining and managing their real records, and a virtual facility table 200 for storing, maintaining, and managing the virtual records of the overlapped facilities representing the real records having the same graphic coordinates.

The virtual facility table 200 includes a graphic coordinate field 220, a common attribute field 230, and a pointer set field 240, and may add an additional field if necessary. The graphic coordinate field 220 stores the graphic coordinates (line, circle, arc, rectangle, polyline, polygon, etc.) of the set of the records of the overlapped facilities having the same coordinates. The common attribute field 230 stores those (attribute fields 1, 2, . . . , n) having the same value among the attribute fields of the records of the facilities. The pointer set field 240 stores the set of the pointers respectively pointing the set of the records of the overlapped facilities.

The facility table 210 includes a virtual facility pointer field 250 and an attribute field 260, and may add an additional field if necessary. The virtual facility pointer field 250 stores the pointers pointing the records of the virtual facility table 200 that is the parent of the records.

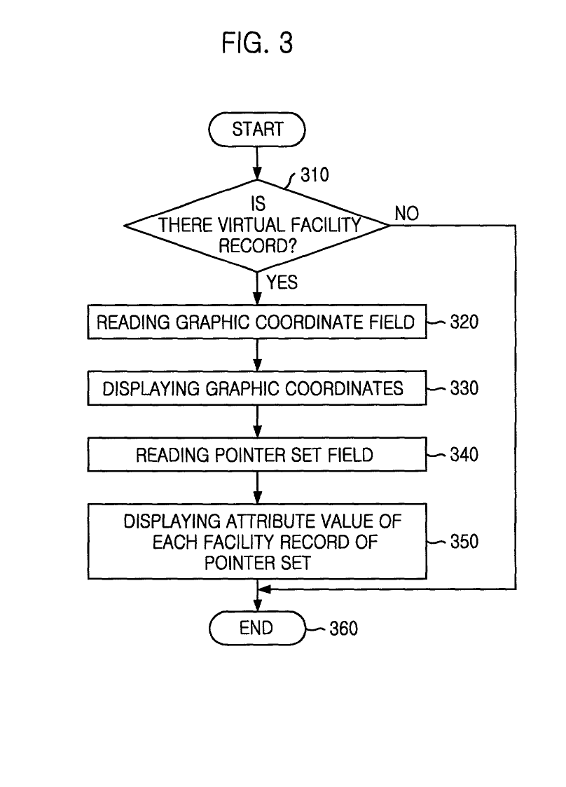

Referring to FIG. 3, the procedure of displaying the data for processing the data of the overlapped facilities is illustrated.

It is determined, at step 310, whether the virtual facility table has the virtual facility record. If there is a record to be read, the graphic coordinate field of the record is detected at step 320. If not, the procedure goes to terminate the procedure. At step 330, a line, circle, arc, rectangle, polyline, polygon, etc. is displayed according to the feature of the graphic coordinates. The pointer set field is read at step 340. The attribute value of each facility record of the pointer set is displayed at step 350, then the procedure is terminated at step 360.

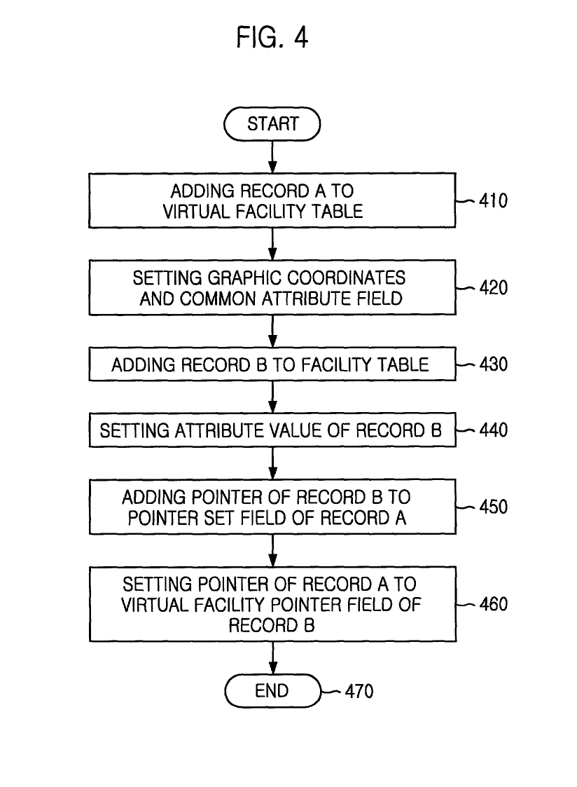

Referring to FIG. 4, the procedure of inputting a new facility in a position different from the graphic coordinates belonging to the existing virtual facility record includes the steps of adding a new record “A” to the virtual facility table at step 410, setting the graphic coordinate field and common attribute field of the additional record “A” to the graphic coordinates and attribute value inputted by the user at step 420, adding a new record “B” to the facility table at step 430, setting the attribute field of the additional record “B” to a value inputted by the user at step 440, adding the pointer of the additional record “B” of the facility table to the pointer set field of the additional record “A” of the virtual facility table at step 450, and setting the pointer of the additional record “A” of the virtual facility table to the virtual facility pointer field of the additional record “B” of the facility table at step 460, then terminating at step 470.

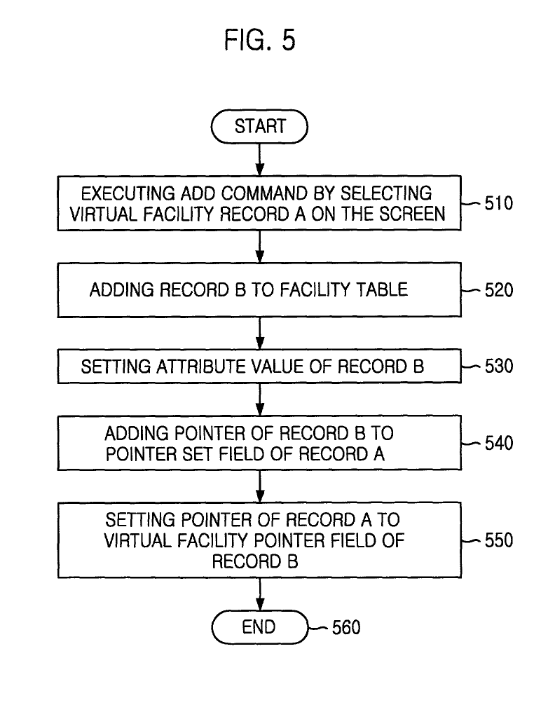

Referring to FIG. 5, the procedure of adding a facility record to the existing virtual facility record comprises the steps of executing the add command by selecting the record “A” of the virtual facility table on the screen providing the GUI (Graphic User Interface) environment at step 510, adding a new record “B” to the facility table at step 520, setting the attribute field of the additional record “B” to a value inputted by the user at step 530, adding the pointer of the additional record “B” to the pointer set field of the record “A” of the virtual facility table at step 540, and setting the pointer of the record “A” for the virtual facility table to the virtual facility pointer field of the additional record “B” at step 550, then terminating at step 560.

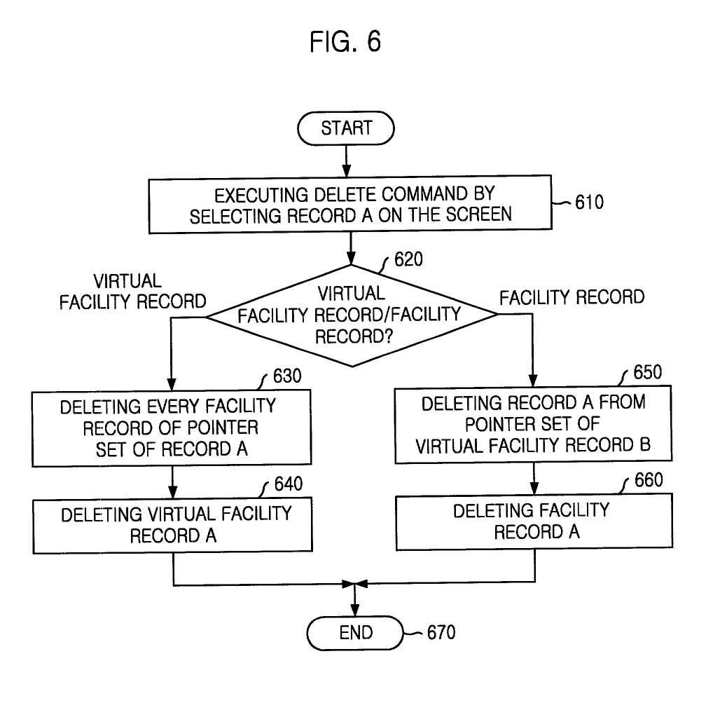

Referring to FIG. 6, the procedure of deleting the existing facility record or virtual facility record comprises the steps of executing delete command by selecting facility or virtual facility record “A” on the screen providing the GUI environment at step 610, determining whether the selection indicates facility record or virtual facility record at step 620, deleting at step 640 the virtual facility record “A” after deleting at step 630 every facility record of the pointer set of the record “A” if the selection indicates the virtual facility record, and terminating at step 670. However, when the selection indicates the facility record, the facility record “A” is deleted at step 660 after deleting at step 650 the record “A” from the pointer set of the virtual facility record “B” designated by the virtual facility pointer of the record “A”.

Thus, this invention separately creates a virtual facility representing the overlapped facilities having the same graphic positions in the layout drawing for managing the facilities, which stores the graphic coordinates, data of the common attributes of the overlapped facilities, and pointers pointing the actual overlapped facilities. This minimizes the size of the database by preventing the data of the overlapped facilities from being multiply stored, effectively used in managing various facilities such as communications, water, gas, electricity, etc. especially through a GIS application program.

Although the preferred embodiments of the invention have been disclosed for illustrative purpose, those skilled in the art will be appreciate that various modifications, additions and substitutions are possible, without departing from the scope and spirit of the invention as disclosed in the accompanying claims.

What is claimed is:

1. An apparatus for processing data of overlapped facilities occupying the same graphical position in a drawing representing their layout by means of virtual facility records, comprising:
a first data processing device for storing, maintaining, and managing the real records of the overlapped facilities; and
a second data processing device for storing, maintaining, and managing the virtual records of the overlapped facilities representing the real records having the same graphic coordinates.

2. The apparatus as recited in claim 1, wherein said second data processing device includes:
a graphic coordinate processor for storing, maintaining, and managing the same graphic coordinates of the real records;
a common attribute processor for storing, maintaining, and managing those having the same value among the attribute fields of the real records of the facilities; and
a pointer set processor for storing, maintaining, and managing the set of pointers for respectively pointing the set of the records of the overlapped facilities.

3. The apparatus as recited in claim 1, wherein said first data processing device includes:
a virtual pointer processor for storing, maintaining, and managing the pointers for pointing the virtual records of overlapped facilities; and
an attribute processor for storing, maintaining, and managing the attributes of the virtual records of the overlapped facilities.

4. A method for processing data of overlapped facilities occupying the same graphical position in a drawing representing their layout by means of virtual facility records, comprising the steps of:
establishing a real facility table by using the real records of the overlapped facilities; and
establishing a virtual facility table by using the virtual records of the overlapped facilities representing the real records having the same graphic coordinates.

5. The method as recited in claim 4, wherein said step of establishing the virtual facility table includes the steps of:
establishing graphic coordinate field by using the data of the graphic coordinates of the set of the records of the overlapped facilities having the same graphic coordinates;
establishing common attribute field by using the data of those having the same value among the attribute fields of the records of the facilities; and
establishing pointer set field by using the set of the pointers respectively pointing the set of the records of the overlapped facilities.

6. The method as recited in claim 4, wherein the step of establishing a real facility table further includes the steps of:
establishing virtual pointer fields by using the data of the pointers pointing the virtual records of overlapped facilities; and
establishing attribute fields by using the data of the attributes of the virtual records of the overlapped facilities.

7. A computer readable recording media storing instructions for executing a method for processing data of overlapped facilities, the method comprising the steps of:
establishing a real facility table by using the real records of the overlapped facilities; and
establishing a virtual facility table by using the virtual records of the overlapped facilities representing the real records having the same graphic coordinates.
